(19) United States
(12) Patent Application Publication
(10) Pub. No.: US 2026/0232011 A1
(43) Pub. Date: Aug. 13, 2026

(54) APPARATUS AND METHOD FOR MANUFACTURING INHALER ARTICLES

(71) Applicant: PHILIP MORRIS PRODUCTS S.A., Neuchatel (CH)

(72) Inventors: Ivan PRESTIA, Calderara di Reno (IT); Elena MALAFRONTE, Santa Maria la Carità (IT)

(21) Appl. No.: 19/471,755

(22) PCT Filed: Apr. 9, 2024
(86) PCT No.: PCT/EP2024/059620

§ 371 Date: Oct. 2, 2025

(30) Foreign Application Priority Data
Apr. 14, 2023 (EP) 23167946.5

(51) Int. Cl. A24C 5/54; A24C 5/02; B65B 7/16; B65B 43/52; B65B 43/60; B65G 15/58

(52) U.S. Cl. CPC A24C 5/54; A24C 5/02; B65B 7/16; B65B 43/52; B65B 43/60; B65G 15/58

(57) ABSTRACT

The invention relates to a filling-and-closing rotating drum for an apparatus for manufacturing inhaler articles. The filling-and-closing rotating drum comprises a plurality of circumferentially arranged grooves. Neighbouring grooves are separated by protruding edges. Each groove comprises a first flute configured for receiving an inhaler article precursor and a second flute configured for receiving an inhaler article precursor. The first and second flutes are arranged between two neighbouring protruding edges. The invention further relates to an apparatus for manufacturing inhaler articles. The invention further relates to a method for manufacturing inhaler articles.

The present invention relates to a filling-and-closing rotating drum. The present invention further relates to an apparatus for manufacturing inhaler articles. The present invention further relates to a method for manufacturing inhaler articles.

Inhaler articles are known in the art, for example dry powder inhalers. In the field of manufacturing inhaler articles, it is known to provide a deformable tubular element and to close a distal end of the deformable tubular element, for example by folding the distal end of the tubular element inwardly. Thereby, an object which has been inserted into the tubular element before, such as a powder capsule, may be securely retained within the article.

It would be desirable to provide an apparatus and a method for manufacturing inhaler articles with less space requirement of the machinery. It would be desirable to provide a more compact apparatus for manufacturing inhaler articles. It would be desirable to provide an apparatus and a method for manufacturing inhaler articles which avoids or reduces the risk of inadvertent shifting of capsules from a desired position in the paper tube during the process.

It would be desirable to provide an apparatus and a method for manufacturing inhaler articles at sufficiently high speed. It would be desirable to provide an apparatus and a method for manufacturing inhaler articles which allow a simplified manufacturing process. It would be desirable to provide an apparatus and a method for manufacturing inhaler articles which require less process steps. It would be desirable to provide an apparatus and a method for manufacturing inhaler articles which allow a simplified process of closing both opposite ends of an inhaler article. It would be desirable to provide an apparatus and a method for manufacturing inhaler articles which allow filling and closing of both ends of a double-length article simultaneously.

According to an embodiment of the present invention there is provided a filling-and-closing rotating drum for an apparatus for manufacturing inhaler articles. The filling-and-closing rotating drum may comprise a plurality of circumferentially arranged grooves. Neighbouring grooves may be separated by protruding edges. Each groove may comprise a first flute configured for receiving an inhaler article precursor. Each groove may comprise a second flute configured for receiving an inhaler article precursor. The first and second flutes of the groove may be arranged between two neighbouring protruding edges.

According to an embodiment of the present invention there is provided a filling-and-closing rotating drum for an apparatus for manufacturing inhaler articles. The filling-and-closing rotating drum comprises a plurality of circumferentially arranged grooves. Neighbouring grooves are separated by protruding edges. Each groove comprises a first flute configured for receiving an inhaler article precursor. Each groove comprises a second flute configured for receiving an inhaler article precursor. The first and second flutes of the groove are arranged between two neighbouring protruding edges. By the filling-and-closing rotating drum, an apparatus for manufacturing inhaler articles with less space requirement of the machinery may be provided. By the filling filling-and-closing rotating drum, a more compact apparatus for manufacturing inhaler articles may be provided. By the filling filling-and-closing rotating drum, an apparatus for manufacturing inhaler articles which avoids or reduces the risk of inadvertent shifting of capsules from a desired position in the paper tube during the process may be provided. For example, since filling and closing occurs on the same drum, there may be less chances to have a capsule running out of the paper tube of an inhaler article precursor in general. Also, risk of capsule shifting from the desired position may be reduced.

By the filling filling-and-closing rotating drum, an apparatus for manufacturing inhaler articles at sufficiently high speed may be provided. By the filling filling-and-closing rotating drum, an apparatus for manufacturing inhaler articles which allows a simplified manufacturing process may be provided. By the filling filling-and-closing rotating drum, an apparatus which requires less process steps may be provided. For example, if filling and closing is conducted separately, a filling drum and a separate closing drum might be required. By the filling filling-and-closing rotating drum, an apparatus for manufacturing inhaler articles which allows a simplified process of closing both opposite ends of an inhaler article may be provided. By the filling filling-and-closing rotating drum, an apparatus for manufacturing inhaler articles which allows filling and closing of both ends of a double-length article simultaneously may be provided.

Each flute may have a size and shape configured for being capable of receiving only one single inhaler article precursor. Each flute may have a size and shape configured for being capable of receiving exactly one single inhaler article precursor. The size and shape of the flute may be adapted to the size and shape of an inhaler article precursor. For example, a width of a flute may be about between 4 millimeters and 10 millimeters. A depth of a flute may be between 2 millimeters and 5 millimeters. A length of a flute may be at least 4 centimeters.

Each flute may comprise a vacuum channel for holding the inhaler article precursor in the flute. The vacuum channel may comprise a supply portion. The supply portion may be in fluid connection to a vacuum supply.

A difference in height between a bottom of a flute and a top of a neighbouring protruding edge may be between 1 millimeter and 10 millimeters, preferably between 2 millimeters and 8 millimeters, more preferably between 3 millimeters and 7 millimeters, more preferably between 4 millimeters and 6 millimeters. The difference in height may be measured along a direction perpendicular to a rotational axis of the filling-and-closing rotating drum.

According to an embodiment of the present invention there is provided an apparatus for manufacturing inhaler articles. The apparatus may comprise a filling-and-closing station. The filling-and-closing station may comprise a filling-and-closing rotating drum configured for receiving a plurality of inhaler article precursors. Each inhaler article precursor may comprise at least one open tubular end. The filling-and-closing station may be configured for both filling and closing the at least one open tubular end of the inhaler article precursors, while the inhaler article precursors are being received by the filling-and-closing rotating drum. The filling-and-closing rotating drum of the apparatus may be a filling-and-closing rotating drum as described herein.

According to an embodiment of the present invention there is provided an apparatus for manufacturing inhaler articles. The apparatus comprises a filling-and-closing station. The filling-and-closing station comprises a filling-and-closing rotating drum configured for receiving a plurality of inhaler article precursors. Each inhaler article precursor comprises at least one open tubular end. The filling-and-closing station is configured for both filling and closing the at least one open tubular end of the inhaler article precursors, while the inhaler article precursors are being received by the filling-and-closing rotating drum.

An apparatus for manufacturing inhaler articles with less space requirement of the machinery may be provided. A more compact apparatus for manufacturing inhaler articles may be provided. An apparatus for manufacturing inhaler articles which avoids or reduces the risk of inadvertent shifting of capsules from a desired position in the paper tube during the process may be provided. An apparatus for manufacturing inhaler articles at sufficiently high speed may be provided. An apparatus for manufacturing inhaler articles which allows a simplified manufacturing process may be provided. An apparatus which requires less process steps may be provided. An apparatus for manufacturing inhaler articles which allows a simplified process of closing both opposite ends of an inhaler article may be provided. An apparatus for manufacturing inhaler articles which allows filling and closing of both ends of a double-length article simultaneously may be provided.

The filling-and-closing rotating drum may be configured to receive the inhaler article precursors such that a longitudinal axis of each inhaler article precursor is oriented in parallel to a rotational axis of the filling-and-closing rotating drum.

The filling-and-closing rotating drum may be oriented in the apparatus such that a rotational axis of the filling-and-closing rotating drum is oriented within a horizontal plane. As used herein, the term “horizontal plane” refers to a plane perpendicular to a vector pointing towards the center of gravity. As used herein, the term “horizontal” refers to a direction or plane being substantially perpendicular to the center of gravity, for example when the apparatus is set up in a production hall.

The apparatus may comprise a fixed rolling hand.

As used herein, the term “fixed” refers to parts which are stationary with respect to moving parts such as a rotating drum or a movable transport surface. For example, the fixed rolling hand does not follow the rotary movement of the filling-and-closing rotating drum. For example, the fixed lay-down hand does not follow the movement of the movable transport surface.

The fixed rolling hand may be arranged for pushing an inhaler article precursor from a first flute to a neighbouring second flute by means of a relative movement of the filling-and-closing rotating drum with respect to the fixed rolling hand.

The filling-and-closing station may comprise a rotating filling-and-closing unit. The rotating filling-and-closing unit may comprise a plurality of circumferentially arranged filling rods. Each filling rod may be configured for filling an object into an open tubular end of an inhaler article precursor. The rotating filling-and-closing unit may comprise a plurality of circumferentially arranged closing rods. Each closing rod may be configured for at least partly closing an open tubular end of an inhaler article precursor. The filling rods and the closing rods may be arranged in alternating sequence. The rotating filling-and-closing unit may be arranged adjacent to the filling-and-closing rotating drum such that a rotational axis of the rotating filling-and-closing unit coincides with a rotational axis of the filling-and-closing rotating drum. The rotating filling-and-closing unit may follow the rotary movement of the filling-and-closing rotating drum. The rotating filling-and-closing unit may thus rotate at the same speed as the filling-and-closing rotating drum.

The filling rods and the closing rods may be arranged in pairs. Each pair of a filling rod and a closing rod comprises one filling rod adjacent to one closing rod.

The rotating filling-and-closing unit may comprise a plurality of circumferentially arranged neutral rods. One neutral rod may be arranged between each pair of a filling rod and a closing rod.

Each filling rod may comprise a plunger cylinder. The plunger cylinder may comprise an opening for object insertion.

Each closing rod may be configured for at least partly closing an open tubular end of an inhaler article precursor by means of one or both of flanging, folding, and curling. Each closing rod may comprise a closing cap. The closing caps be configured for at least partly closing open ends of the inhaler articles by means of one or both of flanging, folding, and curling. The closing caps may be arranged at both sides of the filling-and-closing rotating drum for closing both opposing ends of the inhaler article precursors.

The closing cap may comprise one or more folding heads for folding inwards an open tubular end of the inhaler article. The folding head may be configured for folding the deformable tubular element inwards by at least 90 degrees. The closing cap may comprise a pre-folding head and an end-folding head.

The pre-folding head may be concavely shaped for folding the deformable tubular element inwards by an angle that is smaller than 90 degrees. The end-folding head may be a flat folding head for folding the deformable tubular element inwards by an angle of about 90 degrees. The end-folding head may also comprise be convexly shaped for folding the deformable tubular element inwards by an angle of more than 90 degrees.

The closing cap may comprise one or more curling heads for curling an open tubular end of the inhaler article. The curling head may comprise a longitudinal center axis extending between a proximal end and a distal end of the curling head. The curling head may comprise a circular opening located centrally at the proximal end and defining a recess towards the distal end. The recess may be arranged for insertion of an open tubular end of an inhaler article into the recess. At least a portion of a sidewall of the recess may be arranged as a curling surface. The curling surface may comprise a concave curvature. The curling head may comprise a curling mechanism configured for linearly advancing the curling head along the longitudinal center axis and, simultaneously, rotating the curling head around the longitudinal center axis. The curling mechanism may be driven by one or more motors. The curling mechanism may comprise means for transmitting power from the one or more motors to the curling head.

The curling mechanism may be configured to treat the open end of the article such that the curled end comprises a curled edge circumscribing a central aperture. The curled edge may be a rounded edge.

The filling-and-closing station may comprise one or more pre-treating means for pre-treating the open end of the deformable tubular element of the inhaler article to obtain a pre-treated portion with reduced structural stability. The pre-treating means may be arranged upstream of the one or more closing caps. The pre-treating means may be configured for crimping the edge of the open end of the deformable tubular element. The pre-treating means may be configured for cutting the edge of the open end of the deformable tubular element along one or more lines running generally parallel to the axial direction of the inhaler article. The pre-treating means may be configured for scoring the edge of the open end of the deformable tubular element along one or more lines running generally parallel to the axial direction of the inhaler article. Upon scoring the deformable element may be provided with a discontinuous cutting line. The pre-treating means may include a processing head for creasing, cutting or scoring the open end of the deformable tubular element. The processing head of the pre-treating station may define a generally cylindrical recess, having an inner dimension that corresponds to the outer diameter of the open end of the deformable tubular element. The processing head of the pre-treating station may further comprise a number of treatment blades that extend from the open side wall of the recess of the processing head towards the inner volume of the processing head. The treatment blades may extend funnel shaped towards the inner volume of the processing head. The treatment blades may be spaced equidistantly over the circumference of the recess.

The treatment blades may each have an engagement edge that contacts the open end of the deformable tubular element during the pre-treatment step. The treatment blades may be formed such as to crease, cut or score the open end of the deformable tubular element during the pre-treatment step. The number of the treatment blades determines the number of the creasing, cutting or scoring lines provided to the open end of the deformable tubular element during the pre-treatment step.

The pre-treating means may be provided upstream of the filling-and-closing station.

The filling-and-closing station may comprise a fixed rail unit. The fixed rail unit may comprise a first fixed rail for engaging with the filling rods. The first fixed rail may be configured for manipulating a longitudinal position of each filling rod in dependence of an angular position of the respective filling rod. The fixed rail unit may comprise a second fixed rail for engaging with the closing rods. The second fixed rail may be configured for manipulating the longitudinal position of each closing rod in dependence of the angular position of the respective closing rod. The term “angular position” refers to an angular displacement with respect to a rotational axis of the rotating filling-and-closing unit. The term “longitudinal position” refers to a position along a direction parallel to the rotational axis of the rotating filling-and-closing unit.

Each filling rod may comprise a first cam connected to the first fixed rail. Each closing rod may comprise a second cam connected to the second fixed rail.

The apparatus may be configured for processing single-length inhaler articles. The apparatus may comprise an additional closing station provided downstream of the filling-and-closing rotating drum. The additional closing station may be configured for closing an open end on one side of each of the inhaler articles. The apparatus may be configured for processing double-length inhaler articles. Processing double-length inhaler articles may allow for increased manufacturing speed.

As used herein, the term “processing an article” refers to one or more steps during manufacturing the inhaler article. The term “inhaler article” may refer to a finished or an unfinished article. The term “inhaler article precursor” refers to an unfinished article. The unfinished inhaler article may comprise a deformable tubular element forming an open end of the article. Generally, unfinished inhaler articles are provided at the upstream end of the processing line. The inhaler article received at the downstream end of the processing line may be a finished inhaler article or may require further treatment to finally receive the finished article.

With the terms “upstream” or “downstream”, reference is herein made to the processing direction of the inhaler articles and inhaler article precursors. Generally, the articles are processed or transported in a downstream direction from the upstream end towards the downstream end of the processing line. The terms “processing direction” and “downstream direction” may be used synonymously.

The filling-and-closing rotating drum may be configured for receiving a plurality of double-length inhaler article precursors. Each double-length inhaler article precursor may comprise two open tubular ends. The filling-and-closing station may be configured for both filling and closing each of the two open tubular ends of the inhaler article precursors, while the inhaler article precursors are being received by the filling-and-closing rotating drum. The filling-and-closing station may comprise a further rotating filling-and-closing unit. The filling-and-closing rotating drum may be arranged between the rotating filling-and-closing unit and the further rotating filling-and-closing unit. The rotating filling-and-closing unit and the further rotating filling-and-closing unit and the filling-and-closing rotating drum may share a common rotational axis. The rotating filling-and-closing unit and the further rotating filling-and-closing unit and the filling-and-closing rotating drum may rotate at the same speed.

The apparatus may comprise a cutting station for cutting the double-length inhaler article precursors into halves. The cutting station may be arranged downstream of the filling-and-closing station. The apparatus may comprise a turning station for turning all halved inhaler article precursors in the same direction such that they all have the same orientation of the open ends produced by the cutting. The apparatus may comprise a closing station for closing open tubular ends of the halved inhaler article precursors. The closing station may be arranged downstream of the cutting station. The closing station may be arranged downstream of the turning station.

The filling-and-closing station may comprise a feeder unit for supplying objects to the filling rods. The feeder unit may comprise a movable transport surface comprising a plurality of cavities. Each cavity may have an oblong shape configured for receiving a capsule-shaped object.

The feeder unit may comprise a capsule supply for supplying capsules to the transport surface. The capsule supply may be arranged for inserting the capsules into the cavities such that a longitudinal axis of an inserted capsule is parallel to a longitudinal axis of the oblong cavity.

As used herein, the term “parallel” is not necessarily limited to an angle of exactly 0 degrees, but may in some embodiments include angles deviating to some extent from a strict parallel direction. For example, a deviation of about 15 degrees or less, or about 10 degrees or less, or about 5 degrees or less, or about 2 degrees or less, or about 1 degree or less may be allowable. The term “parallel” may be limited to an angle of about 0 degrees. The term “parallel” may be limited to an angle of 0 degrees.

The feeder unit may comprise a capsule supply for supplying capsules to the transport surface. The capsule supply may be arranged to insert the capsules into the cavities in an upright position, such that a longitudinal axis of an inserted capsule is perpendicular to a longitudinal axis of the oblong cavity.

The oblong cavity may comprise a deeper recessed portion at one side thereof for receiving the capsule in the upright position.

The feeder unit may comprise a fixed lay-down hand being arranged downstream of the capsule supply. The fixed lay-down hand may be configured to, by means of a relative movement of the movable transport surface with respect to the fixed lay-down hand, rotate the capsules in the respective cavities by about ninety degrees such that a longitudinal axis of an inserted capsule is parallel to a longitudinal axis of the oblong cavity. The fixed lay-down hand may be shaped as a triangular plate. The fixed lay-down hand may be shaped as a curved plate. The fixed lay-down hand may be shaped as a triangular curved plate.

The capsule supply may comprise a vibratory feeder bowl.

The movable transport surface may form part of an endless belt or conveyer belt. The movable transport surface may form part of a rotating drum. At least a portion of the movable transport surface may be configured to vibrate. Vibration of the movable transport surface may improve proper insertion of the objects into a cavity of the movable transport surface.

The apparatus may be configured such that the inhaler article precursors are received on the filling-and-closing rotating drum for about two turns of the filling-and-closing rotating drum before being ejected from the filling-and-closing rotating drum. A “turn” means a full rotation of a respective drum.

The apparatus may comprise one or more further rotating drums in addition to the filling-and-closing rotating drum. Each further rotating drum may be located either one of upstream or downstream of the filling-and-closing rotating drum. At least one of the further rotating drums may comprise flutes for receiving the inhaler article precursors. At least one of the further rotating drums may run at the same speed as the filling-and-closing rotating drum. At least one of the further rotating drums may have half as many flutes as the filling-and-closing rotating drum. A further rotating drum may run at the same speed as the filling-and-closing rotating drum and the number of flutes of said further rotating drum may be half the number of flutes of the filling-and-closing rotating drum.

According to an embodiment of the present invention there is provided a method for manufacturing inhaler articles. The method may comprise providing a filling-and-closing rotating drum. The filling-and-closing rotating drum may comprise a plurality of circumferentially arranged flutes, each flute being configured for receiving an inhaler article precursor. The method may comprise receiving, in a first flute, an at least partly filled first inhaler article precursor comprising an open tubular end into which an object has been inserted. The method may comprise receiving, in a second flute, an empty second inhaler article precursor comprising an open tubular end. The method may comprise inserting an object into the open tubular end of the empty second inhaler precursor article to receive an at least partly filled second inhaler article precursor whilst the second inhaler article precursor is being received in the second flute. The method may comprise at least partly closing the open tubular end of the first inhaler article precursor into which the object has been inserted to receive an at least partly closed first inhaler article precursor whilst the first inhaler article precursor is being received in the first flute.

According to an embodiment of the present invention there is provided a method for manufacturing inhaler articles. The method comprises providing a filling-and-closing rotating drum. The filling-and-closing rotating drum comprises a plurality of circumferentially arranged flutes, each flute being configured for receiving an inhaler article precursor. The method comprises receiving, in a first flute, an at least partly filled first inhaler article precursor comprising an open tubular end into which an object has been inserted. The method comprises receiving, in a second flute, an empty second inhaler article precursor comprising an open tubular end. The method comprises inserting an object into the open tubular end of the empty second inhaler precursor article to receive an at least partly filled second inhaler article precursor whilst the second inhaler article precursor is being received in the second flute. The method comprises at least partly closing the open tubular end of the first inhaler article precursor into which the object has been inserted to receive an at least partly closed first inhaler article precursor whilst the first inhaler article precursor is being received in the first flute. The method steps may be conducted consecutively in accordance to the sequence of mentioning above.

A method for manufacturing inhaler articles with less space requirement of the machinery may be provided. A method for manufacturing inhaler articles which avoids or reduces the risk of inadvertent shifting of capsules from a desired position in the paper tube during the process may be provided. A method for manufacturing inhaler articles at sufficiently high speed may be provided. A method for manufacturing inhaler articles which allows a simplified manufacturing process may be provided. A method which requires less process steps may be provided. A simplified method for manufacturing inhaler articles with closing both opposite ends of an inhaler article may be provided. A method for manufacturing inhaler articles which allows filling and closing of both ends of a double-length article simultaneously may be provided.

The first and second flutes may be neighbouring flutes.

The method may comprise a step of removing the at least partly closed first inhaler article precursor from the filling-and-closing rotating drum to re-empty the first flute. The method may comprise a step of moving the at least partly filled second inhaler article precursor from the second flute into the re-emptied first flute.

The step of inserting the object into the open tubular end of the empty second inhaler article precursor, and the step of at least partly closing the open tubular end of the first inhaler article precursor into which the object has been inserted, may be performed simultaneously. The inhaler article precursors may remain being received on the filling-and-closing drum for about two turns of the filling-and-closing drum before being ejected from the drum. A “turn” means a full rotation of the respective drum.

The objects may be capsules, preferably dry powder capsules.

The inhaler article manufactured by the apparatus and method of the invention may comprise a capsule. The capsule may comprise one or more nicotine salts. The capsule may contain pharmaceutically active particles. For instance, the pharmaceutically active particles may comprise nicotine. The pharmaceutically active particles may have a mass median aerodynamic diameter of about 5 micrometers or less, or in a range from about 0.5 micrometer to about 4 micrometers, or in a range from about 1 micrometer to about 3 micrometers. The capsule may comprise one or more nicotine salts.

The capsule may contain nicotine particles comprising nicotine (also referred to as “nicotine powder” or “nicotine particles”) and optionally particles comprising flavour (also referred to as “flavour particles). The capsule may contain a predetermined amount of nicotine particles and optional flavour particles. The capsule may contain enough nicotine particles to provide at least 2 inhalations or “puffs”, or at least about 5 inhalations or “puffs”, or at least about 10 inhalations or “puffs”. The capsule may contain enough nicotine particles to provide from about 5 to about 50 inhalations or “puffs”, or from about 10 to about 30 inhalations or “puffs”. Each inhalation or “puff” may deliver from about 0.1 mg to about 3 mg of nicotine particles to the lungs of the user or from about 0.2 milligrams to about 2 milligrams of nicotine particles to the lungs of the user or about 1 milligram of nicotine particles to the lungs of the user.

The nicotine particles may have any useful concentration of nicotine based on the particular formulation employed. The nicotine particles may have at least about 1 weight-percent nicotine up to about 30 weight-percent nicotine, or from about 2 weight-percent to about 25 weight-percent nicotine, or from about 3 weight-percent to about 20 weight-percent nicotine, or from about 4 weight-percent to about 15 weight-percent nicotine, or from about 5 weight-percent to about 13 weight-percent nicotine. Preferably, about 50 to about 150 micrograms of nicotine may be delivered to the lungs of the user with each inhalation or “puff”. The capsule may hold or contain at least about 5 milligrams of nicotine particles or at least about 10 milligrams of nicotine particles. The capsule may hold or contain less than about 900 milligrams of nicotine particles, or less than about 300 milligrams of nicotine particles, or less than 150 milligrams of nicotine particles. The capsule may hold or contain from about 5 milligrams to about 300 milligrams of nicotine particles or from about 10 milligrams to about 200 milligrams of nicotine particles.

When flavour particles are blended or combined with the nicotine particles within the capsule, the flavour particles may be present in an amount that provides the desired flavour to each inhalation or “puff” delivered to the user.

The nicotine particles may have any useful size distribution for inhalation delivery preferentially into the lungs of a user. The capsule may include particles other than the nicotine particles. The nicotine particles and the other particles may form a powder system.

The capsule may hold or contain at least about 5 milligrams of a dry powder (also referred to as a powder system) or at least about 10 milligrams of a dry powder. The capsule may hold or contain less than about 900 milligrams of a dry powder, or less than about 300 milligrams of a dry powder, or less than about 150 milligrams of a dry powder. The capsule may hold or contain from about 5 milligrams to about 300 milligrams of a dry powder, or from about 10 milligrams to about 200 milligrams of a dry powder, or from about 25 milligrams to about 100 milligrams of a dry powder.

The dry powder or powder system may have at least about 40 percent, or at least about 60 percent, or at least about 80 percent, by weight of the powder system comprised in nicotine particles having a particle size of about 5 micrometers or less, or in a range from about 1 micrometer to about 5 micrometers.

The particles comprising nicotine may have a mass median 5 aerodynamic diameter of about 5 micrometers or less, or in a range from about 0.5 micrometer to about 4 micrometers, or in a range from about 1 micrometer to about 3 micrometers or in a range from about 1.5 micrometers to about 2.5 micrometers. The mass median aerodynamic diameter is preferably measured with a cascade impactor.

The particles comprising flavour may have a mass median aerodynamic diameter of about 20 micrometers or greater, or about 50 micrometers or greater, or in a range from about 50 to about 200 micrometers, or from about 50 to about 150 micrometers. The mass median aerodynamic diameter is preferably measured with a cascade impactor.

The dry powder may have a mean diameter of about 60 micrometers or less, or in a range from about 1 micrometer to about 40 micrometers, or in a range from about 1.5 micrometers to about 25 micrometers. The mean diameter refers to the mean diameter per mass and is preferably measured by laser diffraction, laser diffusion or an electronic microscope.

Nicotine in the powder system or nicotine particles may be a pharmaceutically acceptable free-base nicotine, or nicotine salt, or nicotine salt hydrate. Useful nicotine salts or nicotine salt hydrates include nicotine pyruvate, nicotine citrate, nicotine aspartate, nicotine lactate, nicotine bitartrate, nicotine salicylate, nicotine fumarate, nicotine mono-pyruvate, nicotine glutamate or nicotine hydrochloride, for example. The compound combining with nicotine to form the salt or salt hydrate may be chosen based on its expected pharmacological effect.

The nicotine particles preferably include an amino acid. Preferably, the amino acid may be leucine such as L-leucine. Providing an amino acid such as L-leucine with the particles comprising nicotine, may reduce adhesion forces of the particles comprising nicotine and may reduce attraction between nicotine particles and thus reduce agglomeration of nicotine particles.

Similarly, adhesion forces to particles comprising flavour may also be reduced thus agglomeration of nicotine particles with flavour particles is also reduced. The powder system described herein thus may be a free-flowing material and possess a stable relative particle size of each powder component even when the nicotine particles and the flavour particles are combined.

Preferably, the nicotine may be a surface modified nicotine salt where the nicotine salt particle comprises a coated or composite particle. A preferred coating or composite material may be L-leucine. One particularly useful nicotine particle may be nicotine bi 5 tartrate with L-leucine.

The powder system may include a population of flavour particles. The flavour particles may have any useful size distribution for inhalation delivery selectively into the mouth or buccal cavity of a user.

The powder system may have at least about 40 percent, or at least about 60 percent, or at least about 80 percent, by weight of the population of flavour particles of the powder system comprised in particles having a particle size of about 20 micrometers or greater. The powder system may have at least about 40 percent or at least about 60 percent, or at least about 80 percent, by weight of the population of flavour particles of the powder system comprised in particles having a particle size of about 50 micrometers or greater. The powder system may have at least about 40 percent or at least about 60 percent, or at least about 80 percent, by weight of the population of flavour particles of the powder system comprised in particles having a particle size in a range from about 50 micrometers to about 150 micrometers.

The particles comprising flavour may include a compound to reduce adhesion forces or surface energy and resulting agglomeration. The flavour particle may be surface modified with an adhesion reducing compound to form a coated flavour particle. One preferred adhesion reducing compound may be magnesium stearate. Providing an adhesion reducing compound such as magnesium stearate with the flavour particle, especially coating the flavour particle, may reduce adhesion forces of the particles comprising flavour and may reduce attraction between flavour particles and thus reduce agglomeration of flavour particles. Thus, agglomeration of flavour particles with nicotine particles may also be reduced. The powder system described herein thus may possess a stable relative particle size of the particles comprising nicotine and the particles comprising flavour even when the nicotine particles and the flavour particles are combined. The powder system preferably may be free flowing.

Conventional formulations for dry powder inhalation contain carrier particles that serve to increase the fluidization of the active particles since the active particles may be too small to be influenced by simple airflow though the inhaler. The powder system may comprise carrier particles. These carrier particles may be a saccharide such as lactose or mannitol that may have a particle size greater than about 50 micrometers. The carrier particles may be utilized to improve dose uniformity by acting as a diluent or bulking agent in a formulation.

The powder system utilized with the nicotine powder delivery system described herein may be carrier-free or substantially free of a saccharide such as lactose or mannitol. Being carrier-free or substantially free of a saccharide such as lactose or mannitol may allow the nicotine to be inhaled and delivered to the user's lungs at inhalation or airflow rates that are similar to typical smoking regime inhalation or airflow rates.

The nicotine particles and a flavour may be combined in a single capsule. As described above, the nicotine particles and a flavour may each have reduced adhesion forces that result in a stable particle formulation where the particle size of each component does not substantially change when combined. Alternatively, the powder system includes nicotine particles contained within a single capsule and the flavour particles contained within a second capsule. The nicotine particles and flavour particles may be combined in any useful relative amount so that the flavour particles are detected by the user when consumed with the nicotine particles. Preferably, the nicotine particles and flavour particles form at least about 90 weight-percent or at least about 95 weight-percent or at least about 99 weight-percent or 100 weight-percent of the total weight of the powder system.

The inhaler article manufactured by the apparatus and method of the invention may resemble a smoking article or cigarette in size and shape. The inhaler article may have an elongated body extending along the longitudinal axis of the inhaler article. The inhaler body may have a substantially uniform outer diameter along the length of the elongated body. The inhaler article may have a circular cross-section that may be uniform along the length of the elongated body. The inhaler body may have an outer diameter in a range from about 6 millimeters to about 10 millimeters, or from about 7 millimeters to about 10 millimeters, or about 7 millimeters to about 9 millimeters, or about 7 millimeters to about 8 millimeters or about 7.3 millimeters. The inhaler article may have a length (along the longitudinal axis) in a range from about 40 millimeters to about 80 millimeters, or from about 40 millimeters to about 70 millimeters, or about 40 millimeters to about 50 millimeters, or about 48 millimeters.

The inhaler article may comprise a mouthpiece element. The mouthpiece element may be located proximal to the capsule cavity. The mouthpiece element may extend from the capsule cavity to the mouthpiece end of the inhaler article. The mouthpiece element may have a length in a range from about 10 millimeters to about 30 millimeters, preferably from about 15 millimeters to about 25 millimeters and more preferably from about 20 millimeters to about 22 millimeters. The mouthpiece element may have a diameter in a range from about 6 millimeters to about 10 millimeters, or from about 7 millimeters to about 10 millimeters, or about 7 millimeters to about 9 millimeters, or about 7 millimeters to about 8 millimeters or about 7.1 millimeters. The mouthpiece element may have a filtering function. The mouthpiece element may comprise a filter element. The filter element may extend substantially over the full length of the mouthpiece element.

The inhaler article may comprise a deformable tubular element which has been at least partly closed by the apparatus or method of the invention. The deformable element may be formed of cellulosic material. At least a portion of the deformable element may be formed of paper. The deformable element may provide a barrier to reduce or prevent contaminants or foreign material from entering the capsule cavity.

The inhaler article may comprise a body, a capsule cavity holding a capsule, a mouthpiece element and a deformable tubular element having an at least partly closed end.

The terms “proximal” and “distal” are used to describe the relative positions of components, or portions of components of the inhaler article or system. Inhaler articles, according to the invention have a proximal end. In use, the nicotine particles exit the proximal end of the inhaler article for delivery to a user. The inhaler article has a distal end opposing the proximal end. The proximal end of the inhaler article may also be referred to as the mouth end.

The open tubular end of the inhaler article precursors processed by the apparatus and method of the invention may comprise, or may consist of, a cellulose-based material, for example paper or cardboard. The open tubular end of the inhaler article may comprise, or may consist of, wrapping paper.

Below, there is provided a non-exhaustive list of non-limiting examples. Any one or more of the features of these examples may be combined with any one or more features of another example, embodiment, or aspect described herein.

Example E1: A filling-and-closing rotating drum for an apparatus for manufacturing inhaler articles, the filling-and-closing rotating drum comprising a plurality of circumferentially arranged grooves,
wherein neighbouring grooves are separated by protruding edges, and
wherein each groove comprises a first flute configured for receiving an inhaler article precursor and a second flute configured for receiving an inhaler article precursor, the first and second flutes being arranged between two neighbouring protruding edges.

Example E2: The filling-and-closing rotating drum according to Example E1, wherein each flute comprises a vacuum channel for holding the inhaler article precursor in the flute.

Example E3: The filling-and-closing rotating drum according to Example E1 or Example E2, wherein a difference in height between a bottom of a flute and a top of a neighbouring protruding edge is between 1 millimeter and 10 millimeters, preferably between 2 millimeters and 8 millimeters, more preferably between 3 millimeters and 7 millimeters, more preferably between 4 millimeters and 6 millimeters, the difference in height being measured along a direction perpendicular to a rotational axis of the filling-and-closing rotating drum.

Example E4: An apparatus for manufacturing inhaler articles, the apparatus comprising a filling-and-closing station, the filling-and-closing station comprising a filling-and-closing rotating drum configured for receiving a plurality of inhaler article precursors, each inhaler article precursor comprising at least one open tubular end, wherein the filling-and-closing station is configured for both filling and closing the at least one open tubular end of the inhaler article precursors while the inhaler article precursors are being received by the filling-and-closing rotating drum.

Example E5: The apparatus according to Example E4, wherein the filling-and-closing rotating drum is configured to receive the inhaler article precursors such that a longitudinal axis of each inhaler article precursor is oriented in parallel to a rotational axis of the filling-and-closing rotating drum.

Example E6: The apparatus according to Example E4 or Example E5, wherein the filling-and-closing rotating drum is oriented in the apparatus such that a rotational axis of the filling-and-closing rotating drum is oriented within a horizontal plane.

Example E7: The apparatus according to any of Examples E4 to E6, wherein the filling-and-closing rotating drum is a filling-and-closing rotating drum according to any of Examples E1 to E3.

Example E8: The apparatus according to Example E7, comprising a fixed rolling hand, the fixed rolling hand being arranged for pushing an inhaler article precursor from a first flute to a neighbouring second flute by means of a relative movement of the filling-and-closing rotating drum with respect to the fixed rolling hand.

Example E9: The apparatus according to any of Examples E4 to E8, wherein the filling-and-closing station comprises a rotating filling-and-closing unit, the rotating filling-and-closing unit comprising
a plurality of circumferentially arranged filling rods, each filling rod being configured for filling an object into an open tubular end of an inhaler article precursor; and
a plurality of circumferentially arranged closing rods, each closing rod being configured for at least partly closing an open tubular end of an inhaler article precursor;
wherein the filling rods and the closing rods are arranged in alternating sequence, and
wherein the rotating filling-and-closing unit is arranged adjacent to the filling-and-closing rotating drum such that a rotational axis of the rotating filling-and-closing unit coincides with a rotational axis of the filling-and-closing rotating drum.

Example E10: The apparatus according to Example E9, wherein the filling rods and the closing rods are arranged in pairs, each pair comprising one filling rod adjacent to one closing rod.

Example E11: The apparatus according to Example E10, wherein the rotating filling-and-closing unit comprises a plurality of circumferentially arranged neutral rods, and wherein one neutral rod is arranged between each pair of a filling rod and a closing rod.

Example E12: The apparatus according to any of Examples E9 to E11, wherein each filling rod comprises a plunger cylinder.

Example E13: The apparatus according to Example E12, wherein the plunger cylinder comprises an opening for object insertion.

Example E14: The apparatus according to any of Examples E9 to E13, wherein each closing rod is configured for at least partly closing an open tubular end of an inhaler article precursor by means of one or both of flanging and curling.

Example E15: The apparatus according to any of Examples E9 to E14, wherein the filling-and-closing station comprises a fixed rail unit, the fixed rail unit comprising a first fixed rail for engaging with the filling rods, and a second fixed rail for engaging with the closing rods,
wherein the first fixed rail is configured for manipulating a longitudinal position of each filling rod in dependence of an angular position of the respective filling rod,
wherein the second fixed rail is configured for manipulating the longitudinal position of each closing rod in dependence of the angular position of the respective closing rod,
wherein the angular position refers to an angular displacement with respect to a rotational axis of the rotating filling-and-closing unit, and
wherein the longitudinal position refers to a position along a direction parallel to the rotational axis of the rotating filling-and-closing unit.

Example E16: The apparatus according to Example E15, wherein each filling rod comprises a first cam connected to the first fixed rail, and wherein each closing rod comprises a second cam connected to the second fixed rail.

Example E17: The apparatus according to any of Examples E4 to E16, wherein the filling-and-closing rotating drum is configured for receiving a plurality of double-length inhaler article precursors, each double-length inhaler article precursor comprising two open tubular ends;
wherein the filling-and-closing station is configured for both filling and closing each of the two open tubular ends of the inhaler article precursors while the inhaler article precursors are being received by the filling-and-closing rotating drum,
wherein the filling-and-closing station comprises a further rotating filling-and-closing unit,
wherein the filling-and-closing rotating drum is arranged between the rotating filling-and-closing unit and the further rotating filling-and-closing unit, and
wherein the rotating filling-and-closing units and the filling-and-closing rotating drum share a common rotational axis.

Example E18: The apparatus according to Example E17, comprising a cutting station for cutting the inhaler article precursors into halves, the cutting station being arranged downstream of the filling-and-closing station.

Example E19: The apparatus according to Example E18, comprising a closing station for closing open tubular ends of the halved inhaler article precursors, the closing station being arranged downstream of the cutting station.

Example E20: The apparatus according to any of Examples E9 to E19, wherein the filling-and-closing station comprises a feeder unit for supplying objects to the filling rods, the feeder unit comprising a movable transport surface comprising a plurality of cavities, each cavity having an oblong shape configured for receiving a capsule-shaped object.

Example E21: The apparatus according to Example E20, wherein the feeder unit comprises a capsule supply for supplying capsules to the transport surface, the capsule supply being arranged to insert the capsules into the cavities such that a longitudinal axis of an inserted capsule is parallel to a longitudinal axis of the oblong cavity.

Example E22: The apparatus according to Example E20, wherein the feeder unit comprises a capsule supply for supplying capsules to the transport surface, the capsule supply being arranged to insert the capsules into the cavities in an upright position, such that a longitudinal axis of an inserted capsule is perpendicular to a longitudinal axis of the oblong cavity.

Example E23: The apparatus according to Example E22, wherein the oblong cavity comprises a deeper recessed portion at one side thereof for receiving the capsule in the upright position.

Example E24: The apparatus according to Example E22 or Example E23, wherein the feeder unit comprises a fixed lay-down hand being arranged downstream of the capsule supply and being configured to, by means of a relative movement of the movable transport surface with respect to the fixed lay-down hand, rotate the capsules in the respective cavities by ninety degrees such that a longitudinal axis of an inserted capsule is parallel to a longitudinal axis of the oblong cavity.

Example E25: The apparatus according to any of Examples E21 to E24, wherein the capsule supply comprises a vibratory feeder bowl.

Example E26: The apparatus according to any of Examples E20 to E25, wherein the movable transport surface forms part of an endless belt or a rotating drum.

Example E27: A method for manufacturing inhaler articles, the method comprising
providing a filling-and-closing rotating drum comprising a plurality of circumferentially arranged flutes, each flute being configured for receiving an inhaler article precursor;
receiving, in a first flute, an at least partly filled first inhaler article precursor comprising an open tubular end into which an object has been inserted;
receiving, in a second flute, an empty second inhaler article precursor comprising an open tubular end;
inserting an object into the open tubular end of the empty second inhaler precursor article to receive an at least partly filled second inhaler article precursor whilst the second inhaler article precursor is being received in the second flute; and
at least partly closing the open tubular end of the first inhaler article precursor into which the object has been inserted to receive an at least partly closed first inhaler article precursor whilst the first inhaler article precursor is being received in the first flute.

Example E28: The method according to Example E27, wherein the first and second flutes are neighbouring flutes.

Example E29: The method according to Example E28, comprising
removing the at least partly closed first inhaler article precursor from the filling-and-closing rotating drum to re-empty the first flute; and
moving the at least partly filled second inhaler article precursor from the second flute into the re-emptied first flute.

Example E30: The method according to any of Examples E27 to E29, wherein the step of inserting the object into the open tubular end of the empty second inhaler article precursor, and the step of at least partly closing the open tubular end of the first inhaler article precursor into which the object has been inserted, are performed simultaneously.

Example E31: The method according to any of Examples E27 to E30, wherein the objects are capsules, preferably dry powder capsules.

Features described in relation to one embodiment may equally be applied to other embodiments of the invention.

The invention will be further described, by way of example only, with reference to the accompanying drawings in which:

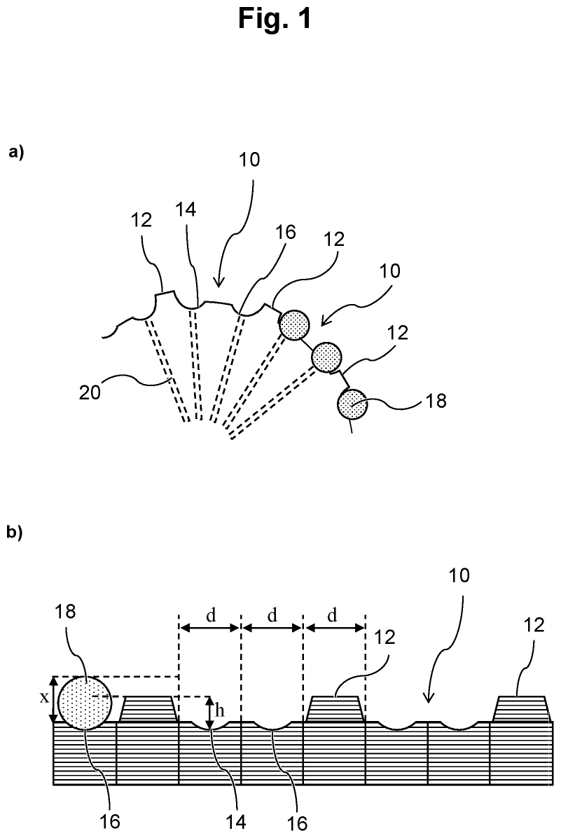

FIGS. 1a and 1b show a filling-and-closing rotating drum;

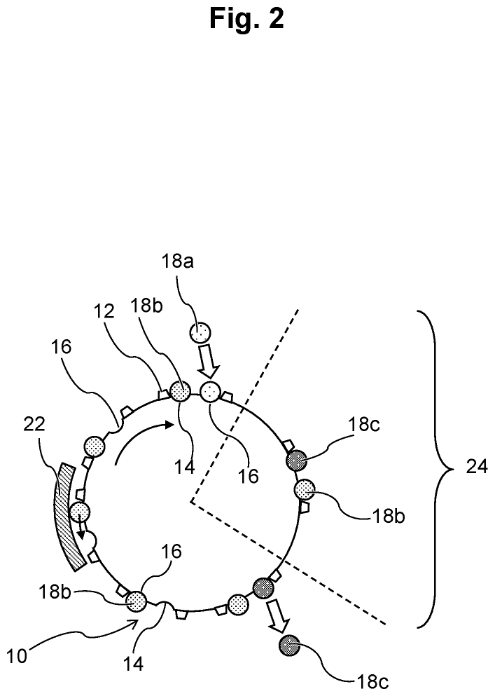

FIG. 2 shows a filling-and-closing rotating drum;

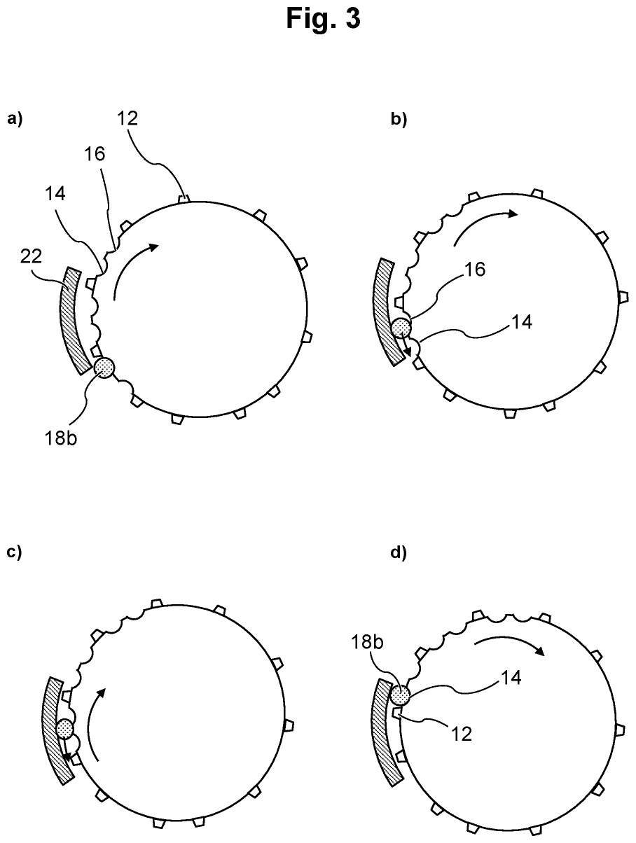

FIGS. 3a to 3d show a filling-and-closing rotating drum;

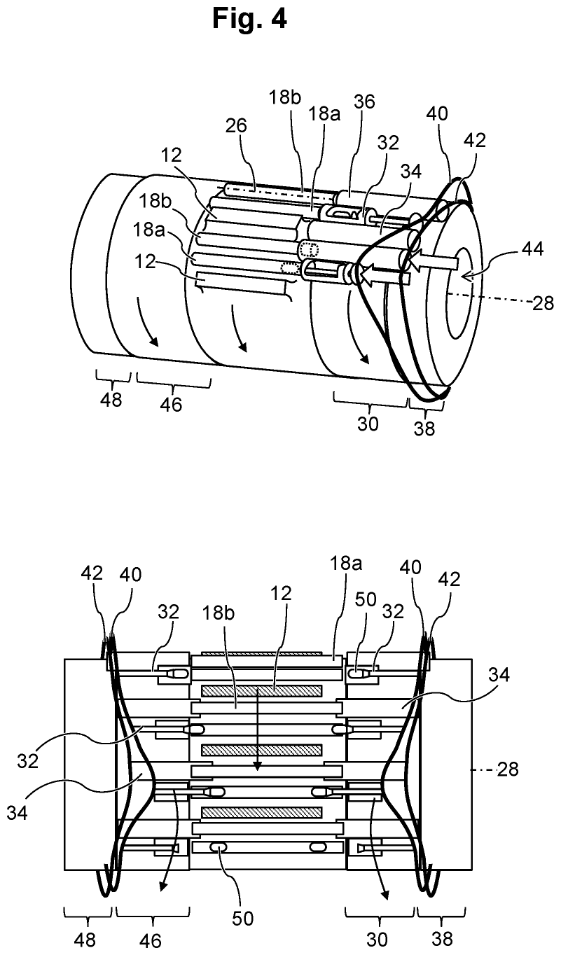

FIGS. 4a and 4b show apparatuses for manufacturing inhaler articles;

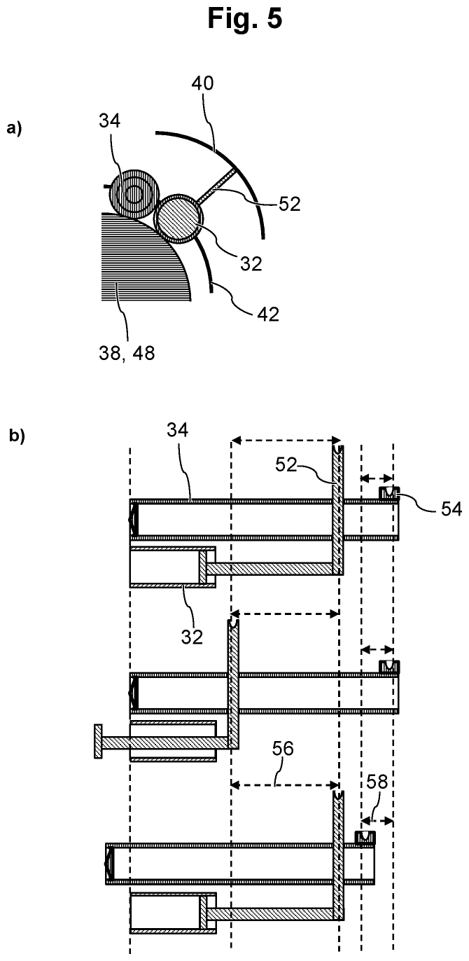

FIGS. 5a and 5b show a filling-and-closing station;

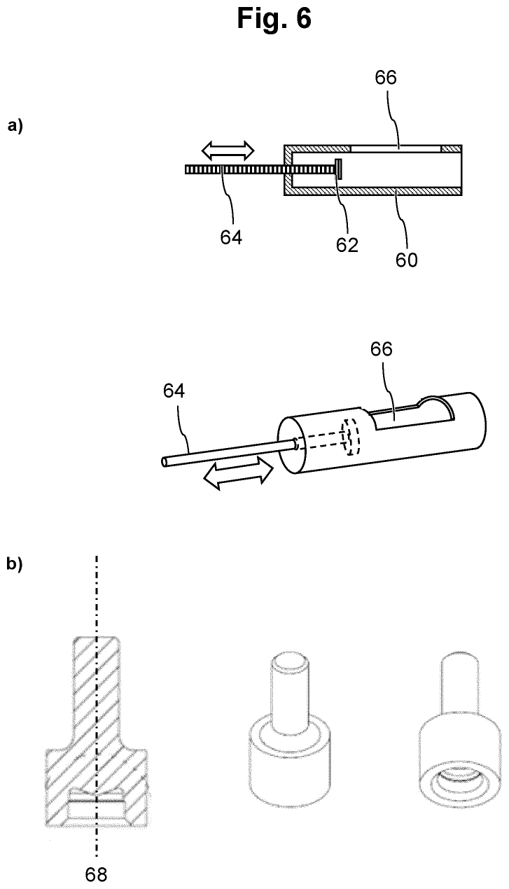

FIG. 6a shows a filling rod;

FIG. 6b shows a closing rod;

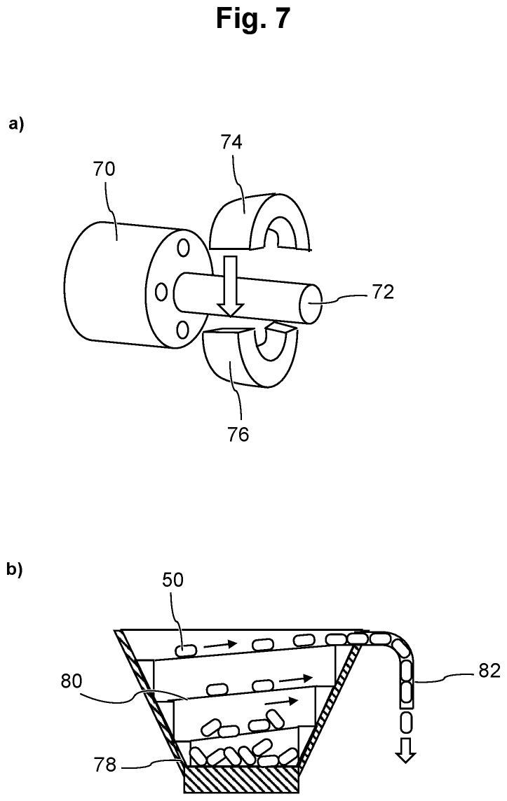

FIG. 7a shows a mounting-dismounting system;

FIG. 7b shows a vibratory feeder bowl;

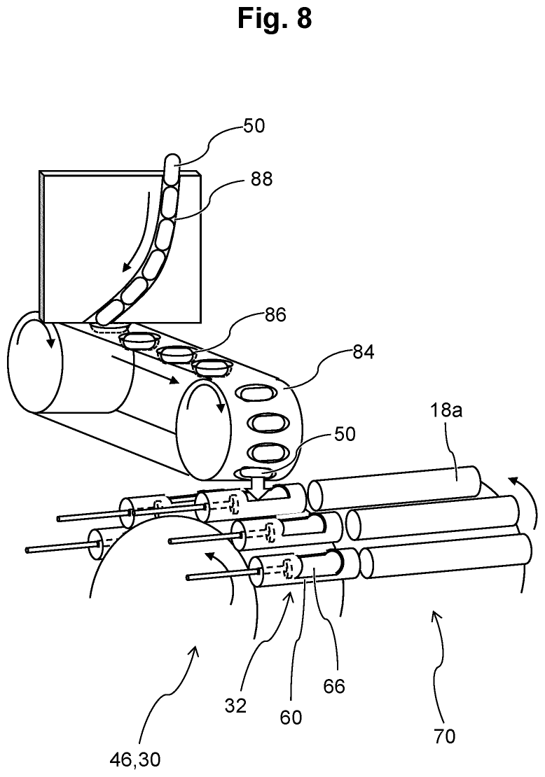

FIG. 8 shows an apparatus for manufacturing inhaler articles;

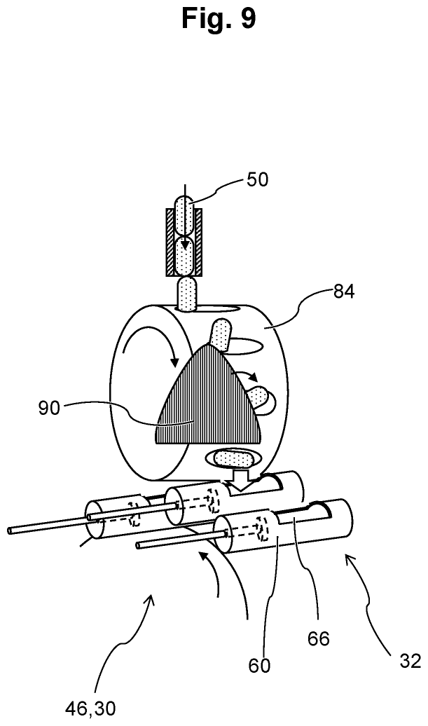

FIG. 9 shows an apparatus for manufacturing inhaler articles;

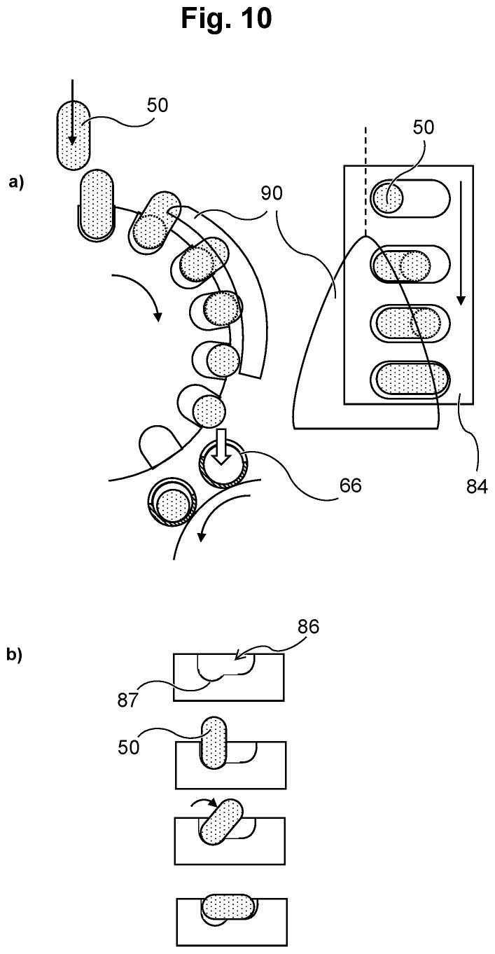

FIGS. 10a and 10b show mechanisms utilizing a fixed lay-down hand;

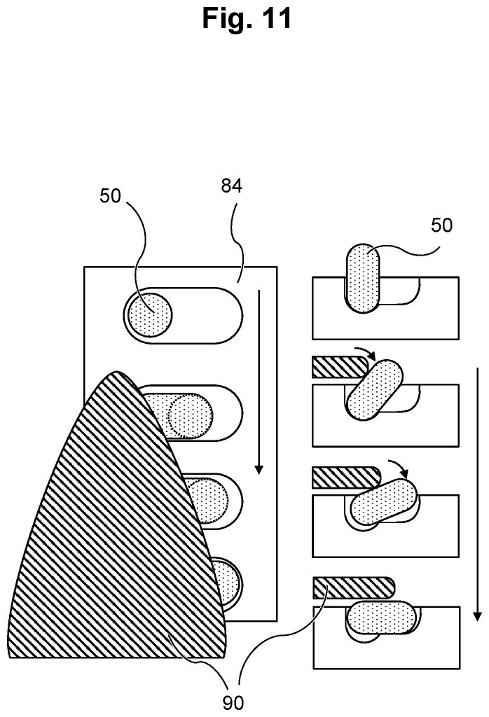

FIG. 11 shows a mechanism utilizing a fixed lay-down hand;

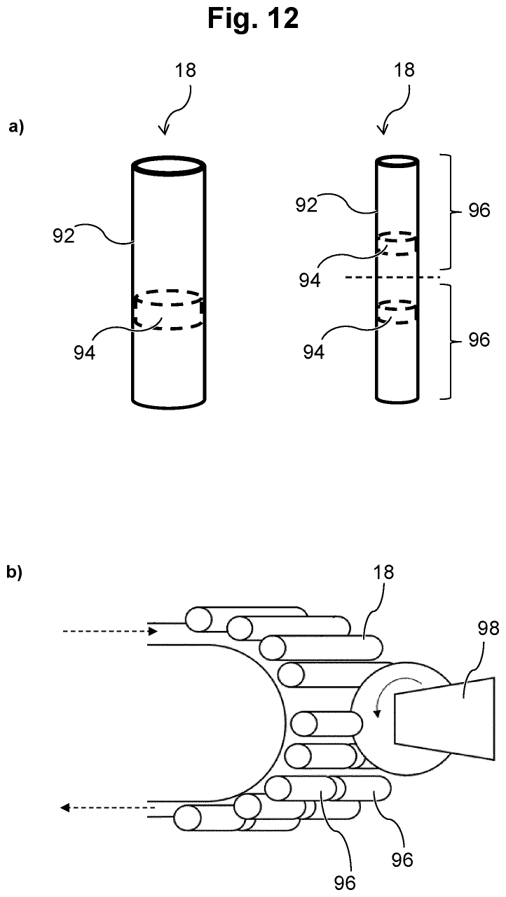

FIG. 12a shows inhaler article precursors;

FIG. 12b shows an apparatus for manufacturing inhaler articles; and

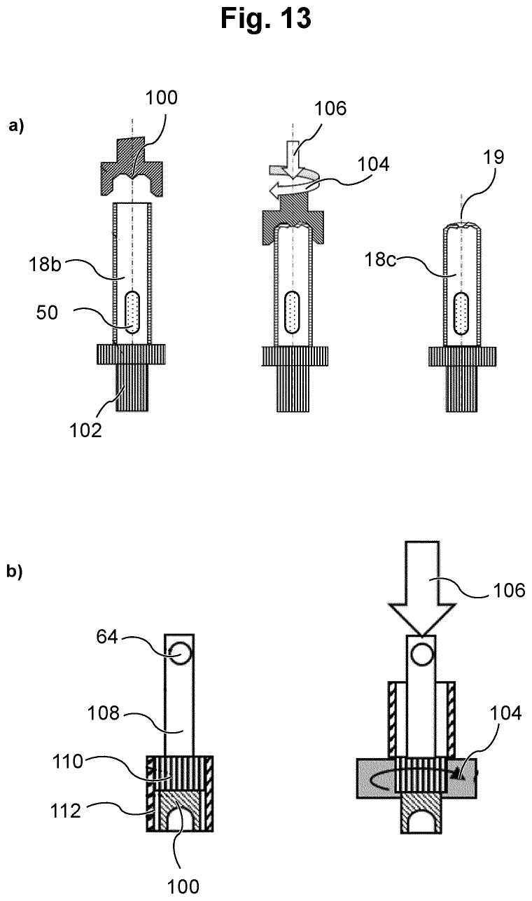

FIGS. 13a and 13b show curling tools.

FIG. 1a shows a part of a filling-and-closing rotating drum for an apparatus for manufacturing inhaler articles in a cross-sectional view. The filling-and-closing rotating drum comprises a plurality of circumferentially arranged grooves 10. Neighbouring grooves 10 are separated by protruding edges 12. Each groove 10 comprises a first flute 14 and a second flute 16. Each flute 14, 16 is configured for receiving an inhaler article precursor 18. The first and second flutes 14, 16 are arranged between two neighbouring protruding edges 12.

Each flute 14, 16 may comprise a vacuum channel 20 for holding the inhaler article precursor 18 in the flute 14, 16.

FIG. 1b shows a part of the filling-and-closing rotating drum of FIG. 1a. In FIG. 1b, the filling-and-closing rotating drum is shown linear for clarity's sake, although it is circular as shown in FIG. 1a. Vacuum channels 20 are not shown in FIG. 1b. The distance ‘d’ between neighbouring flutes 14, 16 as well as the width of a protruding edge is the same.

A difference in height ‘h’ between a bottom of a flute 14, 16 and a top of a neighbouring protruding edge 12 may be between 1 millimeter and 10 millimeters, preferably between 2 millimeters and 8 millimeters, more preferably between 3 millimeters and 7 millimeters, more preferably between 4 millimeters and 6 millimeters. The difference in height ‘h’ is measured along a direction perpendicular to a rotational axis of the filling-and-closing rotating drum.

Advantageously, the filling-and-closing rotating drum is configured such that the difference in height ‘h’ is less than the height ‘x’ of an inhaler article precursor 18 received in a flute 14, 16. Thereby, an optimized functioning of an optional rolling hand, as explained below in conjunction with FIGS. 2 and 3, may be achieved.

FIG. 2 is another depiction of the filling-and-closing rotating drum of FIGS. 1a and 1b together with a fixed rolling hand 22, indicating the method of filling-and-closing the inhaler article precursors. Directions of movement are indicated by arrows.

An incoming empty inhaler article precursor 18a is received at a previously empty flute 16. At that time, the neighbouring flute 14 of the same groove 10 is occupied by a filled inhaler article precursor 18b. Then, as the filling-and-closing rotating drum rotates clockwise, within in a filling-and-closing section 24 of the drum, the empty inhaler article precursor 18a in flute 16 is filled to become a filled inhaler article precursor 18b, and the filled inhaler article precursor 18b in flute 14 is closed to become a filled and closed inhaler article precursor 18c. Then, as the filling-and-closing rotating drum rotates further clockwise beyond the filling-and-closing section 24, the filled and closed inhaler article precursor 18c in flute 14 is removed from the drum, rendering the flute 14 empty. Then, as the filling-and-closing rotating drum rotates further clockwise, the groove 10 having the empty flute 14 and the flute 16 occupied by the filled inhaler article precursor 18b arrives at the fixed rolling hand 22. The fixed rolling hand 22 pushes the filled inhaler article precursor 18b from flute 16 into the neighbouring flute 14. Consequently, another incoming article precursor 18a can be received at the now re-emptied flute 16 as the filling-and-closing rotating drum rotates further.

FIGS. 3a to 3d show the working principle of the fixed rolling hand 22 in more detail.

FIG. 3a shows a filled inhaler article precursor 18b which is received flute 16 approaching the fixed rolling hand 22 as the as the filling-and-closing rotating drum is rotating in a clockwise direction.

FIGS. 3b and 3c show how the fixed rolling hand 22 pushes the filled inhaler article precursor 18b from flute 16 into the neighbouring flute 14 as the filling-and-closing rotating drum rotates further. The frictional forces between the fixed rolling hand 22 and the filled inhaler article precursor 18b are stronger than the suction force of the vacuum channel 20.

As shown in FIG. 3d, the protruding edge 12 next to flute 14 having now received the filled inhaler article precursor 18b inhibits further movement of the filled inhaler article precursor 18b by the fixed rolling hand 22 as the filling-and-closing rotating drum rotates further. The distance between the top of the protruding edge 12 and the bottom of the fixed rolling hand 22 is smaller than the diameter of the filled inhaler article precursor 18b.

FIG. 4a shows an apparatus for manufacturing inhaler articles in perspective view. FIG. 4b shows an apparatus for manufacturing inhaler articles in side view. The apparatuses of FIGS. 4a and 4b comprise a filling-and-closing station. The filling-and-closing station comprises a filling-and-closing rotating drum configured for receiving a plurality of inhaler article precursors, for example the filling and closing rotating drum of any of FIGS. 1 to 3. The filling and closing rotating drum comprises circumferentially arranged protruding edges 12, only some of which are shown in FIG. 4a. Neighbouring flutes 14, 16 (not shown in FIGS. 4a and 4b) have received inhaler article precursors 18a, 18b. Each inhaler article precursor initially comprises at least one open tubular end. The filling-and-closing station is configured for both filling and closing the at least one open tubular end of the inhaler article precursors, while the inhaler article precursors are being received by the filling-and-closing rotating drum.

The filling-and-closing rotating drum is configured to receive the inhaler article precursors 18a, 18b such that a longitudinal axis 26 of each inhaler article precursor is oriented in parallel to a rotational axis 28 of the filling-and-closing rotating drum. The apparatuses may comprise a fixed rolling hand (not shown in FIGS. 4a and 4b).

The filling-and-closing station comprises a rotating filling-and-closing unit 30. The rotating filling-and-closing unit 30 comprises a plurality of circumferentially arranged filling rods 32. Each filling rod 32 is configured for filling an object into an open tubular end of an unfilled inhaler article precursor 18a. The rotating filling-and-closing unit comprises a plurality of circumferentially arranged closing rods 34. Each closing rod 34 is configured for at least partly closing an open tubular end of a filled inhaler article precursor 18b. The filling rods 32 and the closing rods 34 are arranged in alternating sequence. The rotating filling-and-closing unit 30 is arranged adjacent to the filling-and-closing rotating drum such that a rotational axis 28 of the rotating filling-and-closing unit 30 coincides with a rotational axis 28 of the filling-and-closing rotating drum. The rotating filling-and-closing unit 30 follows the rotary movement of the filling-and-closing rotating drum.

The filling rods 32 and the closing rods 34 are arranged in pairs. Each pair of a filling rod 32 and a closing rod 34 comprises one filling rod 32 adjacent to one closing rod 34. The rotating filling-and-closing unit 30 comprises a plurality of optional circumferentially arranged neutral rods 36. One neutral rod 36 is arranged between each pair of a filling rod 32 and a closing rod 34. The presence of the neutral rods 36, in addition to the filling rods 32 and closing rods 34, may ease the stacking of the rods on the station. The presence of the neutral rods 36, may be particularly beneficial when all rods have the same diameter.

The filling-and-closing station comprises a fixed rail unit 38. The fixed rail unit 38 comprises a first fixed rail 40 for engaging with the filling rods 32. The first fixed rail 40 is configured for manipulating a longitudinal position of each filling rod 32 in dependence of an angular position of the respective filling rod 32 as the rotating filling-and-closing unit 30 rotates about the rotational axis 28.

The fixed rail unit 38 comprises a second fixed rail 42 for engaging with the closing rods 34. The second fixed rail 42 is configured for manipulating the longitudinal position of each closing rod 34 in dependence of the angular position of the respective closing rod 34 as the rotating filling-and-closing unit 30 rotates about the rotational axis 28.

The filling-and-closing station may comprise an empty core 44 for a main drum motor shaft.

The filling-and-closing station of FIG. 4a may further comprise a station rotating part 46. The filling-and-closing station of FIG. 4a may further comprise a station fixed part 48. For example, the filling-and-closing rotating drum may be configured for receiving a plurality of double-length inhaler article precursors and the station fixed part 46 may be a further rotating filling-and-closing unit and the station fixed part 48 may be a further fixed rail unit. This is shown in the embodiment of FIG. 4b.

FIG. 4b shows an apparatus for manufacturing inhaler articles in side view. The filling-and-closing rotating drum is configured for receiving a plurality of double-length inhaler article precursors 18a, 18b. Each double-length inhaler article precursor initially comprises two open tubular ends.

The filling-and-closing station may be configured for both filling and closing each of the two open tubular ends of the inhaler article precursors 18, 18b, while the inhaler article precursors 18a, 18b are being received by the filling-and-closing rotating drum. The filling-and-closing station comprises two rotating filling-and-closing units, namely a rotating filling-and-closing unit 30 and a further rotating filling-and-closing unit 46. The filling-and-closing rotating drum is arranged between the rotating filling-and-closing unit 30 and the further rotating filling-and-closing unit 46. The rotating filling-and-closing unit 30 and the further rotating filling-and-closing unit 46 and the filling-and-closing rotating drum share a common rotational axis 28.

Objects 50, preferably dry powder capsules, which are inserted into the empty inhaler article precursor 18a are also shown in FIG. 4b.

FIGS. 5a and 5b show an embodiment of a filling-and-closing station comprising a first fixed rail 40 and a second fixed rail 42.

FIG. 5a shows the fixed rail unit 38 (or the further fixed rail unit 48) in front view along the rotational axis 28. Each filling rod 32 comprises a first cam 52 connected to the first fixed rail 40. Each closing rod 34 may comprise a second cam 54 connected to the second fixed rail 42.

FIG. 5b shows the filling-and-closing station in three different configurations (from top to bottom) in dependence of the angular position of the respective filling rod 32 and closing rod 34. Due to the individual first and second fixed rails 40,42, the movements of the filing and closing rods 32, 34 may be individualized. A left-and-right movement 56 of the filling rods 32 in a direction parallel to the rotational axis 28 is determined by the shape of the first fixed rail 40. A left-and-right movement 58 of the closing rods 32 in a direction parallel to the rotational axis 28 is determined by the shape of the second fixed rail 42.

FIG. 6a shows an embodiment of a filling rod 32 in cross-sectional view (upper part) and in perspective view (lower part). The filling rod 32 comprises a plunger cylinder. The plunger cylinder comprises a tubular element 60, plunger element 62, and a cam follower 64. The tubular element 60 comprises an opening 66 for object insertion. The objects may then be inserted into an open end of an empty inhaler article precursor 18a. For example, the plunger element 62 moves along a longitudinal direction by means of the cam follower 64 being connected to the first fixed rail 40 via a first cam 52 as shown in the embodiment of FIGS. 5a and 5b.

FIG. 6b shows an embodiment of a closing cap for a closing rod 34 in cross-sectional view (left-hand side) and in perspective views (middle and right-hand side). The closing cap is located at the end of the closing rod 34 in a direction towards the open end of the filled inhaler article precursor 18b. By a to-and-fro translational movement of the closing rod 34 and its closing cap (along a direction parallel to the rotational axis 28 and the longitudinal axis 26 of the filled inhaler article precursor 18b) the closing cap is brought into contact with a tubular wall of the open end of the inhaler article precursor 18b. In combination with a rotational movement of the closing cap around its center axis 68, the open end of the inhaler article precursor 18b is closed. Advantageously, the pressure force applied is in a range between 1 Newtons and 10 Newtons.

FIG. 7a shows a mounting-dismounting system for an apparatus for manufacturing inhaler articles in perspective view. Shown is a main drum 70, for example the filling-and-closing rotating drum of any of the embodiments described above. Also shown is a main drum motor shaft 72. The mounting-dismounting system comprises a station having a station first part 74 and a station second part 76. For example, the station may be a station rotating part 46 or a station fixed part 48 as described above. The mounting-dismounting system may allow to easily and rapidly change tools by substituting the previous tool with a different one.

FIG. 7b shows a vibratory feeder bowl for an object supply, preferably a capsule supply, in cross-sectional view. The vibratory feeder bowl comprises a vibratory bowl 78, a slope 80 and an exit pipe 82 for the objects 50, preferably the capsules 50, to exit the vibratory feeder bowl. The objects 50 are put into the vibratory feeder bowl as a bulk and exit the vibratory feeder bowl aligned. In the embodiment shown, the pipe 82 makes the capsules 50 exit in a vertical orientation.

FIG. 8 shows a part of an apparatus for manufacturing inhaler articles in perspective view. Empty inhaler article precursors 18a are received on a main drum 70 of the apparatus, for example the filling-and-closing rotating drum of any of the embodiments described above. The apparatus comprises a station rotating part 46, for example a rotating filling-and-closing unit 30 as described above. The station rotating part 46, 30 comprises a plurality of filling rods 32, for example the filling rods 32 of the embodiment of FIG. 6a.

The apparatus comprises a feeder unit for supplying objects 50 to the filling rods. The feeder unit comprises a movable transport surface 84 of an endless belt. The movable transport surface 84 comprises a plurality of cavities 86. Each cavity 86 has an oblong shape configured for receiving a capsule-shaped object 50, preferably a dry-powder capsule.

The feeder unit comprises a capsule supply for supplying capsules 50 to the transport surface 84. The capsule supply comprises an incoming pipe 88. Preferably, the incoming pipe feeds the capsules 50 to the transport surface 84 at an angle of a longitudinal axis of the capsule 50 with respect to the movable transport surface 84 of less than 45 degrees. Such angle may assure that the capsules 50 are properly falling along the incoming pipe 88, whereas a too small angle might block the pipe. Such angle may assure that the capsules 50 are properly falling into the cavities 86, whereas a too big angle might lead to a vertical insertion.

The capsule supply is arranged for inserting the capsules 50 into the cavities 86 such that a longitudinal axis of an inserted capsule 50 is parallel to a longitudinal axis of the oblong cavity 86. The capsules 50 are inserted into the tubular element 60 of the filling rod 32 via the opening 66.

FIG. 9 shows a part of an apparatus for manufacturing inhaler articles in perspective view. The apparatus comprises a feeder unit with a capsule supply for supplying capsules 50 to a movable transport surface 84 of a rotating drum. The capsule supply is arranged to insert the capsules 50 into oblong cavities 86 of the movable transport surface 84 in an upright position, such that a longitudinal axis of an inserted capsule 50 is perpendicular to a longitudinal axis of the oblong cavity.

The feeder unit comprises a fixed lay-down hand 90 being arranged downstream of the capsule supply. The fixed lay-down hand 90 is shaped as a triangular curved plate. The fixed lay-down hand 90 is configured to, by means of a relative movement of the movable transport surface 84 with respect to the fixed lay-down hand 90, rotate the capsules 50 in the respective cavities 86 by ninety degrees such that a longitudinal axis of an inserted capsule 50 is parallel to a longitudinal axis of the oblong cavity 86.

FIG. 10a shows the mechanism of the fixed lay-down hand 90 of the apparatus of FIG. 9 in a cross-sectional view (left-hand side) and in a front view (right-hand side). The fixed lay-down hand 90 is shown transparent.

FIG. 10b shows a preferred embodiment of the oblong cavity 86 of the apparatus of FIGS. 9 and 10a. The oblong cavity 86 of FIG. 10b comprise a deeper recessed portion 87 at one side thereof for ease of receiving the capsule 50 in the upright position and turning of the capsule 50 by the lay-down hand 90.

FIG. 11 is another depiction showing the mechanism of the embodiment of FIG. 10b in a front view (left-hand side) and a cross-sectional view (right-hand side). As shown at the left-hand side, the tip of the fixed lay-down hand 90 is slightly offset to the cavity, namely to the left of the cavity 86. This may assure that even capsules 50 which are bent slightly out of the cavity 86 may be properly pushed into the cavity 86.

FIG. 12a shows an embodiment of a single length-inhaler article precursor 18 (left-hand side) and an embodiment of a double-length inhaler article precursor 18 (right-hand side). The inhaler article precursors 18 each comprise a paper tube or carton tube 92. Further, the single length-inhaler article precursor 18 comprises one retention plug 94 and the double-length inhaler article precursor 18 comprises two retention plugs 94. The retention plugs 94 provide an inner end wall for an inserted object 50. A dotted line indicates a cutting line for the double-length inhaler article precursor 18 to be cut into halves 96.

FIG. 12b shows, in perspective view, part of an apparatus configured for processing double-length inhaler article precursors 18. The apparatus comprises a cutting station 98 configured for cutting the double-length inhaler article precursors 18 into halves 96. The cutting station 98 comprises a rotary cutter with its movement being indicated by a curved arrow. The cutting station 98 is provided downstream of the filling and closing rotating drum.

FIG. 13a shows an embodiment of a curling tool comprising a rotating cap 100.

While an abutting tool 102 blocks one end of the filled inhaler article precursor 18b, the cap 100 is applied to the open end of the filled inhaler article precursor 18b. The cap 100 is then is rotated (indicated by arrows 104) while pressing on the tube (indicated by arrows 106) as shown in the middle of FIG. 13a, creating an article with a curled and at least partly closed end 19c as shown at the right-hand side of FIG. 13a.

FIG. 13b shows an alternative embodiment of a curling tool comprising a rotating cap 100. The inhaler article precursor 18b, 18c are not shown in FIG. 13b. In the embodiment of FIG. 13b, rotating caps 100 are applied simultaneously at each end of the inhaler article precursor 18b, cancelling the need of an abutting tool 102, and achieving simultaneously the closing of both ends. A fixed rail 42 may guide the cam follower 64 attached to the rod 108. A rotating wheel 110 may move within a chamber 112.

In case double-length inhaler article precursors are processed, once that the inhaler article precursors have been cut into halves, and optionally turned, they may be fed to an additional drum where curling of a remaining free edge occurs. The curling process is following the same concept already described above.

1. A filling-and-closing rotating drum for an apparatus for manufacturing inhaler articles, the filling-and-closing rotating drum comprising a plurality of circumferentially arranged grooves,
wherein neighbouring grooves are separated by protruding edges, and
wherein each groove comprises a first flute configured for receiving an inhaler article precursor and a second flute configured for receiving an inhaler article precursor, the first and second flutes being arranged between two neighbouring protruding edges.

2. The filling-and-closing rotating drum according to claim 1, wherein each flute comprises a vacuum channel for holding the inhaler article precursor in the flute.

3. The filling-and-closing rotating drum according to claim 1 or claim 2, wherein a difference in height between a bottom of a flute and a top of a neighbouring protruding edge is between 1 millimeter and 10 millimeters, the difference in height being measured along a direction perpendicular to a rotational axis of the filling-and-closing rotating drum.

4. An apparatus for manufacturing inhaler articles, the apparatus comprising a filling-and-closing station, the filling-and-closing station comprising a filling-and-closing rotating drum configured for receiving a plurality of inhaler article precursors, each inhaler article precursor comprising at least one open tubular end,
wherein the filling-and-closing station is configured for both filling and closing the at least one open tubular end of the inhaler article precursors while the inhaler article precursors are being received by the filling-and-closing rotating drum.

5. The apparatus according to claim 4, wherein the filling-and-closing rotating drum is configured to receive the inhaler article precursors such that a longitudinal axis of each inhaler article precursor is oriented in parallel to a rotational axis of the filling-and-closing rotating drum, preferably wherein the filling-and-closing rotating drum is oriented in the apparatus such that a rotational axis of the filling-and-closing rotating drum is oriented within a horizontal plane.

6. The apparatus according to claim 4, wherein the filling-and-closing rotating drum is a filling-and-closing rotating drum comprising a plurality of circumferentially arranged grooves,
wherein neighbouring grooves are separated by protruding edges, and
wherein each groove comprises a first flute configured for receiving an inhaler article precursor and a second flute configured for receiving an inhaler article precursor, the first and second flutes being arranged between two neighbouring protruding edges.

7. The apparatus according to claim 6, comprising a fixed rolling hand, the fixed rolling hand being arranged for pushing an inhaler article precursor from a first flute to a neighbouring second flute by means of a relative movement of the filling-and-closing rotating drum with respect to the fixed rolling hand.

8. The apparatus according to claim 4, wherein the filling-and-closing station comprises a rotating filling-and-closing unit, the rotating filling-and-closing unit comprising
a plurality of circumferentially arranged filling rods, each filling rod being configured for filling an object into an open tubular end of an inhaler article precursor; and
a plurality of circumferentially arranged closing rods, each closing rod being configured for at least partly closing an open tubular end of an inhaler article precursor;
wherein the filling rods and the closing rods are arranged in alternating sequence, and
wherein the rotating filling-and-closing unit is arranged adjacent to the filling-and-closing rotating drum such that a rotational axis of the rotating filling-and-closing unit coincides with a rotational axis of the filling-and-closing rotating drum.

9. The apparatus according to claim 8, wherein the filling rods and the closing rods are arranged in pairs, each pair comprising one filling rod adjacent to one closing rod.

10. The apparatus according to claim 8, wherein the filling-and-closing station comprises a fixed rail unit, the fixed rail unit comprising a first fixed rail for engaging with the filling rods, and a second fixed rail for engaging with the closing rods,
wherein the first fixed rail is configured for manipulating a longitudinal position of each filling rod in dependence of an angular position of the respective filling rod,
wherein the second fixed rail is configured for manipulating the longitudinal position of each closing rod in dependence of the angular position of the respective closing rod,
wherein the angular position refers to an angular displacement with respect to a rotational axis of the rotating filling-and-closing unit, and
wherein the longitudinal position refers to a position along a direction parallel to the rotational axis of the rotating filling-and-closing unit.

11. The apparatus according to claim 4 wherein the filling-and-closing rotating drum is configured for receiving a plurality of double-length inhaler article precursors, each double-length inhaler article precursor comprising two open tubular ends;
wherein the filling-and-closing station is configured for both filling and closing each of the two open tubular ends of the inhaler article precursors while the inhaler article precursors are being received by the filling-and-closing rotating drum,
wherein the filling-and-closing station comprises a further rotating filling-and-closing unit,
wherein the filling-and-closing rotating drum is arranged between the rotating filling-and-closing unit and the further rotating filling-and-closing unit, and
wherein the rotating filling-and-closing units and the filling-and-closing rotating drum share a common rotational axis.

12. The apparatus according to claim 8, wherein the filling-and-closing station comprises a feeder unit for supplying objects to the filling rods, the feeder unit comprising a movable transport surface comprising a plurality of cavities, each cavity having an oblong shape configured for receiving a capsule-shaped object.

13. The apparatus according to claim 12, wherein the feeder unit comprises a capsule supply for supplying capsules to the transport surface, the capsule supply being arranged to insert the capsules into the cavities such that a longitudinal axis of an inserted capsule is parallel to a longitudinal axis of the oblong cavity.

14. The apparatus according to claim 12, wherein the feeder unit comprises a capsule supply for supplying capsules to the transport surface, the capsule supply being arranged to insert the capsules into the cavities in an upright position, such that a longitudinal axis of an inserted capsule is perpendicular to a longitudinal axis of the oblong cavity, preferably
wherein the oblong cavity comprises a deeper recessed portion at one side thereof for receiving the capsule in the upright position, and/or
wherein the feeder unit comprises a fixed lay-down hand being arranged downstream of the capsule supply and being configured to, by means of a relative movement of the movable transport surface with respect to the fixed lay-down hand, rotate the capsules in the respective cavities by ninety degrees such that a longitudinal axis of an inserted capsule is parallel to a longitudinal axis of the oblong cavity.

15. A method for manufacturing inhaler articles, the method comprising
providing a filling-and-closing rotating drum comprising a plurality of circumferentially arranged flutes, each flute being configured for receiving an inhaler article precursor;
receiving, in a first flute, an at least partly filled first inhaler article precursor comprising an open tubular end into which an object has been inserted;
receiving, in a second flute, an empty second inhaler article precursor comprising an open tubular end;
inserting an object into the open tubular end of the empty second inhaler precursor article to receive an at least partly filled second inhaler article precursor whilst the second inhaler article precursor is being received in the second flute; and
at least partly closing the open tubular end of the first inhaler article precursor into which the object has been inserted to receive an at least partly closed first inhaler article precursor whilst the first inhaler article precursor is being received in the first flute.
